(19) United States
(12) Patent Application Publication
(10) Pub. No.: US 2008/0054835 A1
(43) Pub. Date: Mar. 6, 2008

(54) Method and apparatus for controlling motor for vehicles

(75) Inventor: Takuya Tamaru, Kariya-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/896,602

(22) Filed: Sep. 4, 2007

(30) Foreign Application Priority Data
Sep. 1, 2006 (JP) 2006-237887

(51) Int. Cl. H02P 7/00; G05D 23/00

(52) U.S. Cl. 318/634; 318/473; 318/479

(57) ABSTRACT

An apparatus is provided for controlling drive of a motor mounted on a vehicle and formed to have a rotor and a stator equipped with a plurality of phases of coils to be supplied by current in turn, phase by phase, to rotate the rotor. The apparatus comprises a voltage detector, temperature detector, setting block, and current-supply block. Of these, the voltage detector detects a voltage of power to be applied to the motor, while the temperature detector detects a temperature of the motor. The setting block uses the detected temperature and the detected voltage of the power to set a target torque at which the motor should generate a torque. The current-supply block supplies current to the motor so that the motor generates the torque on the target torque set by the setting block.

### CROSS-REFERENCE TO RELATED APPLICATION

This application is based on and claims the benefit of priority from earlier Japanese Patent Application No. 2006-237887 filed Sep. 1, 2006, the description of which is incorporated herein by reference.

### BACKGROUND OF THE INVENTION

1. Field of the Invention

The present invention relates to a motor control apparatus for vehicles for controlling driving of an on-vehicle motor, which includes a rotor and a stator having a plurality of coils, and is configured to rotate the rotor by supplying current to the coils with sequentially switching phases to which the current is supplied.

2. Related Art

Various types of motors have been utilized as driving sources for driving various actuators in vehicles. In particular, reluctance motors typically represented by switched reluctance motors (hereinafter each referred to as an “SR motor”) have such merits as requiring no permanent magnet, having a simple structure, enabling use under high-temperature conditions, and enabling high-speed revolution. For these reasons, reluctance motors are achieving widespread use in a broad range of technical fields, such as in shift range switching mechanisms for vehicles and in electric vehicles.

As a method for controlling an SR motor, Japanese Patent Application Laid-Open No. 2004-129452, for example, discloses a method in which a pattern for switching phases to be supplied with current (hereinafter each referred to as a “current-supplied phase”) is provided based on a waveform of an encoder output, and current is supplied to each of the phases according to the switching pattern.

The method for controlling an SR motor disclosed in the literature mentioned above, however, determines the switching pattern for the current-supplied phases only based on the waveform of the encoder output. Accordingly, this method may not achieve an appropriate torque control depending on the conditions of the vehicle on which the SR motor is loaded or degrees of variations in the components of the SR motor.

Generally, control apparatuses are designed so that a demanded torque can be satisfied in case various conditions (hereinafter, also referred to as “particular conditions”), including a usage environment of a motor (e.g., ambient temperature) or tolerance of a motor, are the worst (e.g. in case of being in high temperature or being at the lower limit in the tolerance range of dimensional variation caused by assembling). Specifically, higher temperatures may result in larger impedance of a motor, hardly allowing a current to flow, and may also result in smaller torque. Even under the same conditions, the larger the gap dimension is between a rotor and a stator than a design center value (i.e. the closer the gap dimension is to the lower limit in a tolerance range), the smaller the obtained torque becomes. Therefore, control apparatuses are designed so that a demanded torque can be satisfied even when the particular conditions, such as the usage environment or the tolerance, are bad as mentioned above.

However, designing the control apparatuses anticipating the worst particular conditions may contrarily bring about unnecessarily large torque when the apparatuses are in good condition, for example, when they are in low temperatures or close to the upper limit in the tolerance range of dimensional variations caused by assembling. As a result, the members to be driven (objects to be controlled) by the motor may have a breakdown.

In order to solve this problem, it is necessary to perform appropriate torque control. One approach for the appropriate torque control is to perform current feedback control (hereinafter referred to as “current F/B”), in which current that passes through a coil is detected, and the detected current is adjusted while being monitored. A specific example of such a circuit is shown in FIG. 16. FIG. 16 shows in a simplified manner a control circuit for controlling an SR motor having a three-phase coil made up of a U-phase coil 81, a V-phase coil 82 and a W-phase coil 83.

As shown in FIG. 16, current supply paths for the coils 81, 82 and 83 of the individual phases (hereinafter each referred as a “phase coil”) of the SR motor are connected with MOSFETs (hereinafter each simply referred to as an “FET”) 84, 85 and 86, respectively, serving as switching elements for switching on/off current supply to the phase coils 81, 82 and 83. Current detection resistors 87, 88 and 89 are connected to the downstream side of the switching elements to detect power supply current that flows through the individual phases. The current detection resistors 87, 88 and 89 are connected at one end thereof (the upstream side) to current detection circuits 91, 92 and 93, respectively. The current detection circuits 91, 92 and 93 output values of power supply current (practically, values of voltage corresponding to the current) flowing through the respective phase coils 81, 82 and 83, which values are then inputted to a CPU 96 through an A/D converter 97. The CPU 96 monitors the values of the power supply current of the phase coils 81, 82 and 83 inputted through the A/D converter to realize the current F/B control. FIG. 17 shows one example of a pattern of current supply to the phase coils 81, 82 and 83 (switching of current-supplied phases). In the figure, “ON” indicates a period when the FET of a corresponding phase is switched on so that current is supplied thereto, and “OFF” indicates a period when the FET of a corresponding phase is switched off so that the current supply thereto is stopped.

The current F/B control, however, entails providing a current detection resistor and a current detection circuit for each of the current supply paths of the respective phase coils 81, 82 and 83 in the motor, raising a problem that the circuit is unavoidably enlarged.

One solution for the problem may be to provide one common current detection resistor and one common current detection circuit for the phase coils 81, 82 and 83. In particular, the sources of the three FETs 84, 85 and 86 are connected to a single current detection resistor to detect power supply currents using only the current detection resistor and a current detection circuit connected thereto.

However, a motor, such as the SR motor, for which current is supplied by sequentially switching the current-supplied phases, generally involves periods, as shown in FIG. 17, when two or more phases simultaneously require current supply (i.e. overlapped current supply). Accordingly, use of a single current detection resistor and a single current detection circuit may bring about a difficulty in individually detecting the power supply currents that flow through the respective phases, and thus cannot be applied to actual products.

### SUMMARY OF THE INVENTION

The present invention has been made in light of the problem described above and has as its object to provide a motor control apparatus for vehicles, which enables a motor to generate appropriate torque with a simple configuration, irrespective of the variation in the particular conditions, such as usage environment or assembling conditions (individual differences or dimensional variations).

In order to achieve the object, the present invention provides an apparatus for controlling drive of a motor mounted on a vehicle and formed to have a rotor and a stator equipped with a plurality of phases of coils to be supplied by current in turn, phase by phase, to rotate the rotor. The apparatus comprises a voltage detector that detects a voltage of power to be applied to the motor; a temperature detector that detects a temperature of the motor; a setting block that uses the detected temperature and the detected voltage of the power to set a target torque at which the motor should generate a torque; and a current-supply block that supplies current to the motor so that the motor generates the torque on the target torque set by the setting block.

Specifically, temperature and power source voltage of a motor at the time when the motor is actually supplied with current and driven, are detected to set an appropriate target torque corresponding to the detected actual temperature and power source voltage. Then, actual current supply is carried out so that the set target torque can be achieved.

Thus, the motor control apparatus for vehicles having the above configuration can perform current supply control suitable for temperature by setting a target torque based on detected temperature and power source voltage. Accordingly, irrespective of the level of the temperature at which the motor is used, suitable torque can be generated in the motor with a simple configuration.

Various specific methods may be given for setting a target torque by using the target torque setting means (the setting block). For example, utilizing the fact that a lower temperature can render the coil impedance to become so much the less to allow for easier current flow, the target torque may be set in inverse proportion to the temperature to prevent in advance the torque from becoming excessively large. Contrarily, utilizing the fact that a lower temperature allows for easier current flow (i.e. achieves a larger torque), the lower the temperature is, so much the larger target torque may be set to obtain a large torque. However, in either of the cases, it is preferable that an upper limit is provided to the target torque and that a torque exceeding the upper limit should not be set as a target torque, as will be described later.

As an example of the temperature detecting means (the temperature detector) for detecting temperature of a motor, a temperature detector, such as a semiconductor temperature sensor, may be arranged proximate to a motor or its coils, so that temperature can be directly detected.

Generally, however, such a temperature detector cannot provide uniform characteristics over a wide temperature range (e.g. from −4° C. to 120° C.). For this reason, in order to achieve a uniform and accurate detection of temperature that varies in a wide range, some measure should be taken, for example, by employing detectors for particular temperature ranges, such as detectors for low, middle and high temperature ranges. However, this may increase the size and cost of the control apparatus. Moreover, a semiconductor temperature sensor would achieve accurate detection of temperature only for the portion where the sensor is attached, and thus it is quite likely that no accurate temperature detection can actually be achieved for the entire coils of the motor.

It is preferred that the temperature detector comprises a current supplier that supplies current to, of the plurality of phases of the coils, one or more coils of corresponding one or more phases on a given current-supply pattern; a current detecting, which are used in common among the plurality of phases of coils, that detects a current flowing when the current supplier supplies the current on the given current-supply pattern; a first calculator that calculates an impedance of the one or more coils supplied with the current by the current supplier, on the basis of the detected voltage of the power and the current detected by the current detector; and a second calculator that calculates, as an alternative amount to the temperature of the motor, a temperature of the coil on the basis of the impedance calculated by the first calculator and a reference impedance previously set for the one or more coils at a given reference temperature.

The calculation of impedance by the impedance calculating means (the first calculator) can be readily performed using the well known Ohm's law. Also, the calculation of temperature by the coil temperature calculating means (the second calculator) can be readily performed using a temperature coefficient and utilizing the known arithmetic expression for deriving an impedance (resistance) corresponding to the temperature. As a specific example, an impedance R calculated by the impedance calculating means can be expressed by the following formula (1):

R=R₀*{1+β(T−T₀)} (1)

where T₀ is a design reference temperature, R₀ is a reference impedance corresponding to the design reference temperature T₀, β is a temperature coefficient and T is a temperature to be calculated. The formula (1) is well known, and use of this formula (1) may enable calculation for obtaining the actual temperature T of a coil.

In other words, according to the mode of the present invention described above, a temperature detector, such as the semiconductor temperature sensor mentioned above, is not separately provided for temperature detection, but the actual impedance R is calculated and based on the calculated impedance R, the actual temperature T is detected (calculated) utilizing the above formula (1). In this way, temperature of the coils can be accurately detected with a simple configuration (a configuration required for the above calculation) without requiring a temperature sensor or the like.

As mentioned above, the reference impedance of a coil is used when the coil temperature calculating means performs calculation of coil temperature. Since this reference impedance is just a design center value, the actual reference impedance of the motor does not necessarily coincide with this reference impedance. As a matter of fact, the actual reference impedance in general is offset, more or less, from the design center value, depending on the individual differences (differences in the number of turns in a winding of a coil or the size of a coil) of individual motors.

It is still preferred that the apparatus further comprises an actual impedance detector that detects an actual impedance of the one or more coils at the reference temperature; an impedance compensating-amount calculator that calculates a compensating (correcting) amount for the reference impedance on the basis of the actual impedance of the one or more coils and the reference impedance; and a storage storing therein the compensating amount for the reference impedance; wherein the second calculator is configured to correct the reference impedance on the compensating amount stored in the first storage and to calculate the temperature of the coil using the compensated reference impedance.

As to the compensation of the reference impedance based on the reference impedance compensation amount, if, for example, the reference impedance compensation amount is the “ratio” mentioned above, the reference impedance may be multiplied by the reference impedance compensation amount. If, on the other hand, the reference impedance compensation amount is the “difference” mentioned above, the reference impedance may be added with the reference impedance compensation amount. For example, in case the reference impedance compensation amount is the “difference”, the above formula (1) can be expressed by the following formula (2):

R=(R₀+α)*{1+β(T−T₀)} (2)

where α is the reference impedance compensation amount.

According to the above mode of motor control apparatus for vehicles configured in this way, the design center value is not used as reference impedance in a single uniform way, but actual reference impedance is used to calculate temperature of coils. Thus, the temperature of the coils can be accurately detected irrespective of the individual differences (differences in the number of turns in a winding of a coil or the size of a coil) of the individual motors. As a result, the actual current supplying means can supply current according to a target torque that has been set based on the accurately detected temperature of the coils.

It is still preferred that the actual impedance detector comprises current supply means (the current supplier) that supplies, at the reference temperature, current to, of the plurality of phases of the coils, one or more coils of corresponding one or more phases on a given current-supply pattern; current detecting means (the current detector), which are used in common among the plurality of phases of coils, that detects, at the reference temperature, a current flowing when the current supply means supplies the current on the given current-supply pattern; and impedance calculating means (the second calculator) that calculates an impedance of the one or more coils supplied with the current by the current supply means, on the basis of the detected voltage of the power and the current detected by the current detecting means. In particular, the impedance obtained under the reference temperature conditions as mentioned above, can serve as the actual reference impedance of the motor (coils).

In addition, the present invention still provides various operations and advantages, which are as follows.

As described above, various specific methods may be given for setting a target torque by the target torque setting means. In particular, even in a case where the particular conditions, such as the usage environment or the assembling of the motor, are good and thus a large torque can be generated, a torque exceeding the upper limit will not be set as a target torque.

Thus, setting an upper limit in a target torque can prevent generation of the exceedingly large torque irrespective of the usage environment or the individual differences of the motors. The target torque map refers to a map in which target torques corresponding to respective temperatures and power source voltages of a motor are set.

Thus, a suitable target torque can be readily set by providing and using the target torque reference map. It is preferable that, as to the target torque set by the target torque setting means as well, compensation is appropriately made according to the individual differences of the individual motors as in the case of the reference impedance described above. Specifically, current supply with the same temperature and the same power source voltage may naturally bring about different results for every motor, depending on the individual difference of the motors (e.g., dimensional variations in the individual members, such as rotors or stators, or dimensional variations between the individual members caused at the time of assembling). Accordingly, setting a target torque in a single uniform way according to the temperature and the power source voltage, regardless of the individual differences of motors, may be anticipated to cause generation of a torque significantly exceeding a set value, or contrarily, generation of a torque significantly lower than the set value, depending on the motors.

The torque compensation amount calculating means calculates, as a torque compensation amount, the ratio of a reference torque, which is a design center value of the toque generated when current is supplied with a predetermined current supply pattern under the conditions of a reference temperature, to an actually measured torque, which is obtained through measurement when current is actually supplied with the predetermined current supply pattern under the conditions of the reference temperature. Alternatively, the difference between the former and the latter is calculated as a torque compensation amount.

More specifically, prior to the actual current supply performed by the actual current supplying means (i.e. prior to the actual use of the motor), a torque compensation amount is calculated by the torque compensation amount calculating means, and the calculated torque compensation amount is stored in the second storing means. After that, in the actual current supply performed by the actual current supplying means, the target torque compensating means can compensate the target torque set by the target torque setting means, and the actual current supplying means can perform current supply based on the compensated target torque.

As to the compensation of a target torque based on the torque compensation amount, if, for example, the torque compensation amount is the “ratio” mentioned above, the target may be multiplied by the torque compensation amount. If, on the other hand, the torque compensation amount is the “difference” mentioned above, the target torque may be added with the torque compensation amount.

The motor control apparatus for vehicles configured in this way according to the mode of the present invention described above, does not use the target torque as it is set by the target torque setting means (a design center value) but uses a torque obtained by compensating the target torque set by the target torque setting means according to the individual difference of the motor, so that the actual current supplying means can supply current to the motor. Thus, more suitable current supply can be performed regardless of the individual difference of the motor (e.g., dimensional variations).

In performing current supply by the actual current supplying means, various advantages are gained. Specifically, as in the case of the target torque map described above, setting a current supply pattern also involves use of an actual current supply pattern map in which the power source voltages and the target torques are mapped. Thus, once the power source voltage is detected and the target torque is set, an actual current supply pattern can be univocally determined, whereby a suitable current supply pattern can be readily determined.

In the current supply pattern for each phase, based on which the actual current supplying means supplies current to each of the phases, current may be normally continuously supplied during a current supply period, while the period of continuous current supply may be varied as shown in FIG. 17 according to the target torque. Alternatively, for example, duty current supply may be performed throughout the current supply period, while varying the duty ratio according to the target torque. In this way, various current supply patterns can be set.

Specifically, the actual current supply pattern includes a continuous current supply period in which current is supplied continuously from the beginning of the period, and a duty current supply period in which current is supplied at a predetermined duty ratio subsequent to the continuous current supply period.

Since the coils to be supplied with current are inductive loads for a power source, current flow can be insufficient immediately after starting current supply, but then the power supply current gradually increases. Accordingly, it is difficult to obtain a desired torque immediately after starting current supply. Thus, if the duty current supply is performed immediately after starting current supply under the conditions where a desired torque cannot even be achieved immediately after starting current supply, longer time may be required before achieving the desired torque.

Under the circumstances mentioned above, current may be continuously supplied for a certain period after starting current supply, so that the desired torque can be generated as promptly as possible after starting the current supply. After the power supply current has been sufficiently increased, the duty current supply may be performed to contrarily prevent an excessive torque from being generated.

In this way, application of the current supply pattern described above to the individual phases of the coils can suppress the torque variation, while generating torque of suitable value.

It should be appreciated that “not to detect power source voltage” literally means not to detect power source voltage as a matter of course, but also means that the results of detection per se are rendered to be ineffective and are not utilized.

During the operation of the start up motor, the power source voltage is so reduced that current supply to a motor is difficult to be normally performed. However, since the above mode of the present invention does not detect the power source voltage while the start up motor is in operation, malfunction of the motor can be avoided, and resultantly, the quality and reliability of the motor control apparatus can be enhanced.

There may be various specific methods for determining the normality of the power source voltage. For example, an allowable range can be predetermined, and then a detected power source voltage may be determined as to whether or not it falls within the allowable range. Alternatively, for example, sampling may be performed for a plurality of times at a predetermined interval to determine whether or not all or an average of the power source voltages falls within the allowable range.

In this way, by providing the power source voltage determining means, a power source voltage, which is not normal, is rendered to be ineffective in an abnormal circumstance where the power source is instantaneously disconnected, for example. Thus, malfunction of the motor can be avoided, whereby quality and reliability of the motor control apparatus can resultantly be enhanced.

Further, there may be various motors that can serve as a motor of the present invention, but one possible motor may be the one described in the foregoing embodiment. A switched reluctance motor has such advantages that it can dispense with a permanent magnet to provide a simple structure at low cost, and have high durability and reliability under varying temperature conditions or the like. Thus, a switched reluctance motor is suitable for loading on a vehicle.

Also, there may be various objects, which are to be driven by a motor, but one possible object may be the one describe in the foregoing. In this case, a torque suitable for the shift range switching mechanism can be provided to enable good shift range switching.

Specifically, a motor to be controlled and an apparatus for controlling the motor can be integrated (modularized). Such an integrated motor control apparatus for vehicles can reliably have various types of information according the electrical and mechanical characteristics of the integrated motor, so that the individual difference of the motor can be reliably absorbed, while more reliably performing appropriate control. The various types of information here include, for example, a target torque, reference impedance compensation amount, target torque map, torque compensation amount and actual current supply pattern. In case a motor and a control apparatus for controlling the motor are established being physically apart from each other, and both of them are connected via a harness or the like, the accuracy of the torque control may be lowered being influenced by the voltage drop caused by the harness. However, the integration of the motor and the control apparatus no longer entails consideration for such an influence of the voltage drop, so that high accuracy control can be effected for a target torque. In addition, the integration can enhance control responsiveness.

### BRIEF DESCRIPTION OF THE DRAWINGS

In the accompanying drawings:

FIG. 1 is a schematic perspective view illustrating a configuration of a shift range switching mechanism according to an embodiment of the present invention;

FIG. 2 is a schematic cross-sectional view illustrating a configuration of a switching/driving apparatus;

FIG. 3 is an explanatory view illustrating a configuration of an SR motor;

FIG. 4 is an explanatory view illustrating an electrical configuration of the switching/driving apparatus;

FIG. 5 is an explanatory view illustrating a process flow executed in the switching/driving apparatus from the point of the factory shipment to the point of the actual use;

FIG. 6 is a flow diagram illustrating an initial assemblage error learning process executed at the time of the factory shipment;

FIG. 7 is an explanatory view illustrating a reference current supply pattern in calculating impedance;

FIG. 8 is a flow diagram illustrating a motor temperature learning process executed after the loading of the switching/driving apparatus on a vehicle;

FIG. 9 is a flow diagram illustrating a current supply pattern calculation process executed by using the results of the motor temperature learning process;

FIG. 10 is a graph illustrating a target torque reference map;

FIG. 11 is an explanatory view illustrating the contents set in a current supply pattern;

FIG. 12 is a graph illustrating a current supply pattern reference map;

FIG. 13 is an explanatory view illustrating a current supply pattern of an entire SR motor according to the embodiment of the present invention;

FIG. 14 is an explanatory view illustrating a modification of the reference current supply pattern;

FIG. 15 is an explanatory view illustrating a modification of the contents set in the current supply pattern;

FIG. 16 is an explanatory view schematically illustrating a configuration of a conventional motor control circuit; and

FIG. 17 is an explanatory view illustrating a current supply pattern of an entire conventional SR motor.

### DESCRIPTION OF THE PREFERRED EMBODIMENTS

With reference to the accompanying drawings, hereinafter is described an embodiment in which the present invention is applied to a shift range switching mechanism.

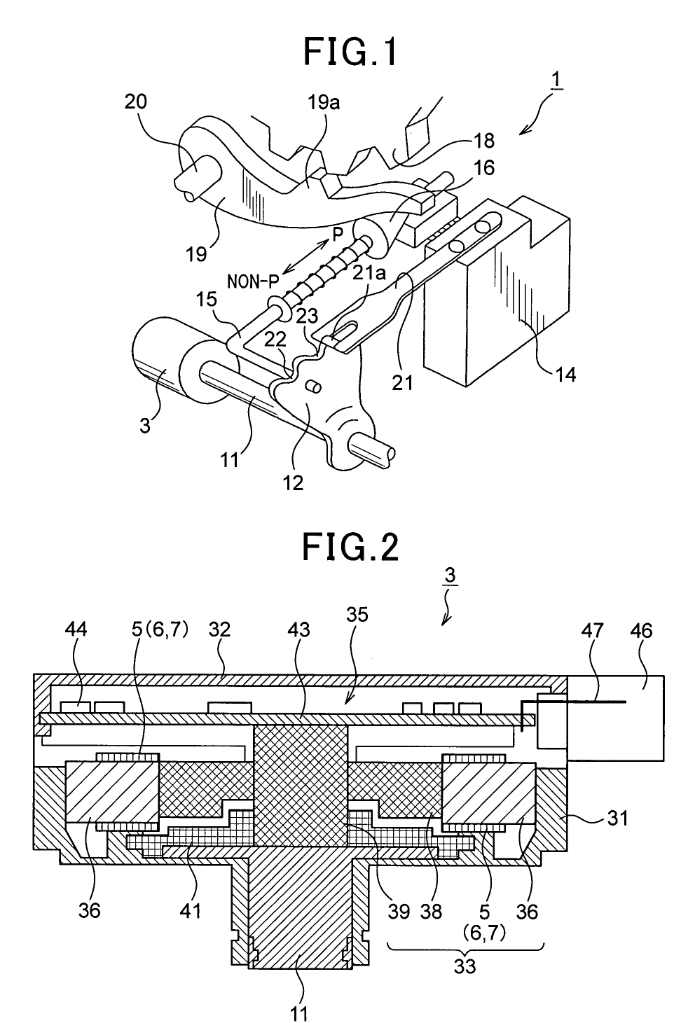

Referring to FIG. 1, an explanation is given first on a configuration of a shift range switching mechanism 1 according the present embodiment. The purpose of the shift range switching mechanism 1 is to switch a shift range in response to a driver's operation of a shift lever, and is provided with a switching/driving apparatus 3 as a drive source. To simplify the explanation, the following description will be focused on a switching operation from a parking range (hereinafter referred to as a “P range”) to other ranges (hereinafter referred to as a “non-P range”), or vice versa, in the entire shift range switching operation.

A detailed configuration of the switching/driving apparatus 3 (see FIG. 2, for example) will be described later, but to put it briefly, the switching/driving apparatus 3 includes a switched reluctance motor (SR motor) 33, an output shaft 11, and a motor control ECU 35 serving as an electronic control unit (ECU) for controlling the driving of the SR motor 33. The switching/driving apparatus 3 also includes an output shaft sensor (not shown) for detecting a rotational position of the output shaft 11.

A detent lever 12 is fixed to the output shaft 11 of the switching/driving apparatus 3. An L-shaped parking rod 15 is fixed to the detent lever 12, with a conical member 16 provided at the tip portion of the parking rod 15 being in contact with a lock lever 19. The lock lever 19 is adapted to vertically rotate about a shaft 20 according to the position of the conical member 16 to lock/unlock a parking gear 18. The parking gear is provided at an output shaft of an automatic transmission (not shown). When the parking gear 18 is locked by the lock lever 19, drive wheels of the vehicle are kept in a state of being detented (parked state).

A detent spring 21 for keeping the detent lever 12 in the P range and the non-P range is fixed to a support base 14, with an engaging portion 21a being provided at a tip of the detent spring 21. Upon engagement of the engaging portion 21a of the detent spring 21 with a P range keeping recess 22 of the detent lever 12, the detent lever 12 is held at a position of the P range. Contrarily, upon engagement of the engaging portion 21a of the detent spring 21 with a non-P range keeping recess 23 of the detent lever 12, the detent lever 12 is held at a position of the non-P range.

In the P range, the parking rod 15 moves in a direction of approaching the lock lever 19, so that a thick portion of the conical member 16 pushes up the lock lever 19 to bring a projection 19a of the lock lever 19 into engagement with the parking gear 18 and to lock the parking gear 18. As a result, the output shaft (drive wheels) of the automatic transmission is brought into a state of being locked (parked state).

In the non-P range, the parking rod 15 moves in a direction of departing from the lock lever 19, so that the thick portion of the conical member 16 is pulled out of the lock lever 19 to push down the lock lever 19 and disengage the projection 19a of the lock lever 19 from the parking gear 18. As a result, the parking gear 18 is unlocked to bring the output shaft of the automatic transmission into a rotatable state (ready-to-travel state).

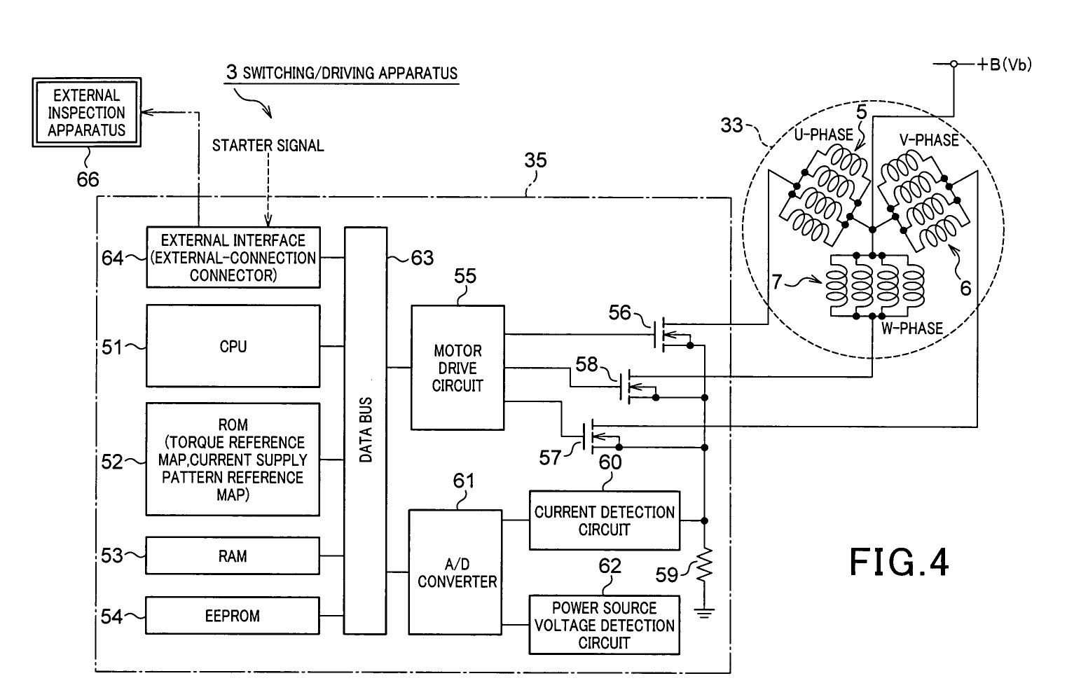

Referring now to FIG. 2, a configuration of the switching/driving apparatus 3 is described. As shown in FIG. 2, the switching/driving apparatus 3 includes the SR motor 33, the output shaft 11 and the motor control ECU 35. The motor control ECU 35 is provided therein with various circuits or the like for driving and controlling the SR motor 33 (see FIG. 4). Details of the motor control ECU 35 will be described later.

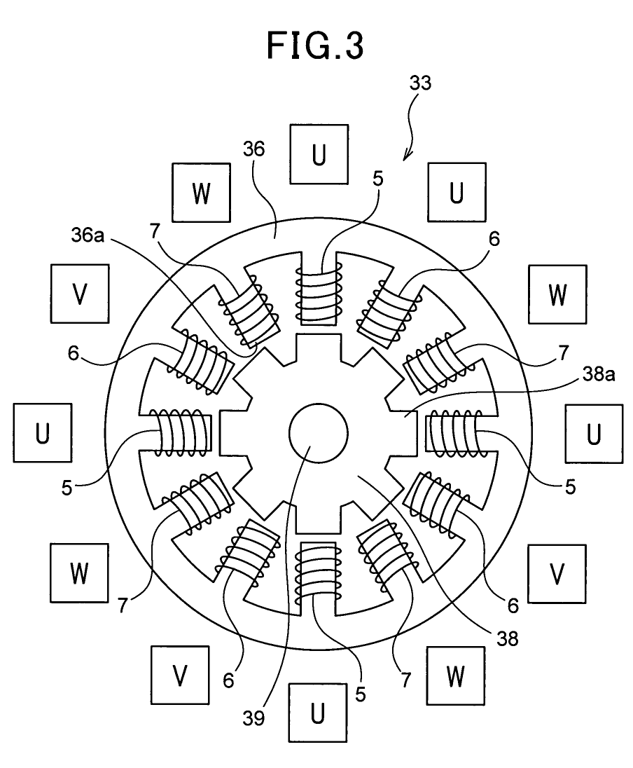

As shown in FIGS. 2 and 3, the SR motor 33 has a stator 36 and a rotor 38, both of which have a projected polar structure. SR motors in general, including the SR motor 33 of the present embodiment, have such merits as requiring no permanent magnet, having a simple structure, being usable under high-temperature conditions, and being able to rotate at high speed, and are beginning to be utilized in various technical fields including, for example, shift range switching mechanisms, such as the one in the present embodiment, and electric vehicles.

An inner periphery of the cylindrical stator 36 is formed with twelve projected poles 36a at an even interval. An outer periphery of the rotor 38, which is opposed to the inner periphery of the stator 36, is formed with eight projected poles 38a at an even interval. As the rotor 38 rotates, the projected poles 38a of the rotor 38 are adapted to sequentially face the projected poles 36a of the stator through a very small gap. A U-phase coil 5, a V-phase coil 6 and a W-phase coil 7 as one set, a total of four sets of the coils are wound, in this order, about the respective twelve projected poles 36a of the stator 36. Specifically, as is apparent from FIG. 3, four repetitions of the coils, each in the order of the U-phase coil 5, V-phase coil 6 and W-phase coil 7, are wound about the respective projected poles 36a provided along the inner periphery of the stator 36. As shown in FIG. 4, the four coils of each phase are connected in parallel. Accordingly, when current is supplied to the U-phase, all four of the U-phase coils 5 are parallelly energized. The same applies to the V- and W-phase coils.

The SR motor 33 and the motor control ECU 35 are integrally accommodated in a casing consisting of a case 31 and a cover 32 to constitute the switching/driving apparatus 3. In other words, the switching/driving apparatus 3 of the present embodiment has a mechanical-electronic integrated configuration, in which the SR motor 33 and the motor control ECU 35 for driving and controlling the SR motor 33 are integrated. In the case 31, a shaft 39 of the rotor 38 of the SR motor 33 is linked to the output shaft 11 through a deceleration mechanism 41.

The motor control ECU 35 includes a circuit board 43, on which a plurality of parts 44, such as a CPU 51 and drive elements 56, 57 and 58 (see FIG. 4), constituting various circuits for controlling the driving of the SR motor 33 are mounted. The switching/driving apparatus 3 is provided with an external-connection connector 46, to which an external inspection apparatus 66 (see FIG. 4) is connected when the switching/driving apparatus 3 is shipped from the manufacturing factory, or other apparatuses of a vehicle are connected when the switching/driving apparatus 3 is loaded on the vehicle. Details of the external inspection apparatus 66 will be described later. The external-connection connector 46 has a plurality of terminal pins 47, one end of each of which is connected to a predetermined wiring pattern on the circuit board 43. Thus, the motor control ECU 35 and external objects to be connected are electrically connected through the terminal pins 47.

Referring to FIG. 4, an electrical configuration of the switching/driving apparatus 3 will be described. As shown in the figure, the SR motor 33 includes parallelly connected four U-phase coils 5, parallelly connected four V-phase coils 6 and parallelly connected four W-phase coils 7, which are Y-connected. One end of each of the coils in each phase is connected to a power source voltage Vb (+B) and the other end thereof is connected to a switching element in the motor control ECU 35.

Specifically, the motor control ECU 35 is provided with three FETs 56, 57 and 58 that serve as switching elements for individually turning on/off the current supply to the coils of the individual phases 5, 6 and 7 (i.e., phase coils 5, 6 and 7). A drain of the FET 56 is connected to one end of each of the U-phase coils 5. A drain of the FET 57 is connected to one end of each of the V-phase coils 6. Similarly, a drain of the FET 58 is connected to one end of each of the W-phase coils 7. Gates of the respective FETs 56, 57 and 58 are connected to a motor drive circuit 55. Sources of the FETs 56, 57 and 58 are connected to one end of a current detection resistor 59 as well as the current detection circuit 60. The other end of the current detection resistor 59 is connected to a ground potential.

Accordingly, current supply to the U-phase coils 5 is performed by turning on the FET 56 which is connected to the U-phase coils 5. In particular, when the FET 56 is turned on, current is supplied to the four U-phase coils 5 from a battery (not shown) as a power source (power source voltage Vb) loaded on the vehicle. Similarly, current supply to the V-phase coils 6 is performed by turning on the FET 57 which is connected to the V-phase coils 6. In particular, when the FET 57 is turned on, current is supplied to the four V-phase coils 6 from the battery (not shown) as the power source (power source voltage Vb) loaded on the vehicle. Similarly, current supply to the W-phase coils 7 is performed by turning on the FET 58 which is connected to the W-phase coils 7. In particular, when the FET 58 is turned on, current is supplied to the four W-phase coils 7 from the battery (not shown) as the power source (power source voltage Vb) loaded on the vehicle.

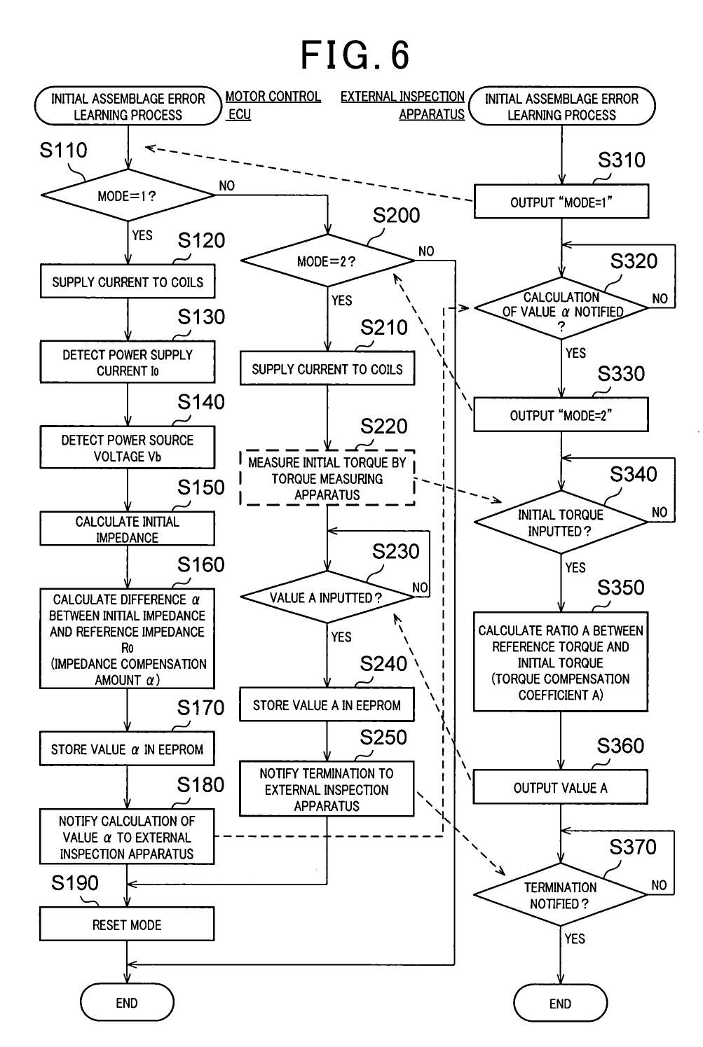

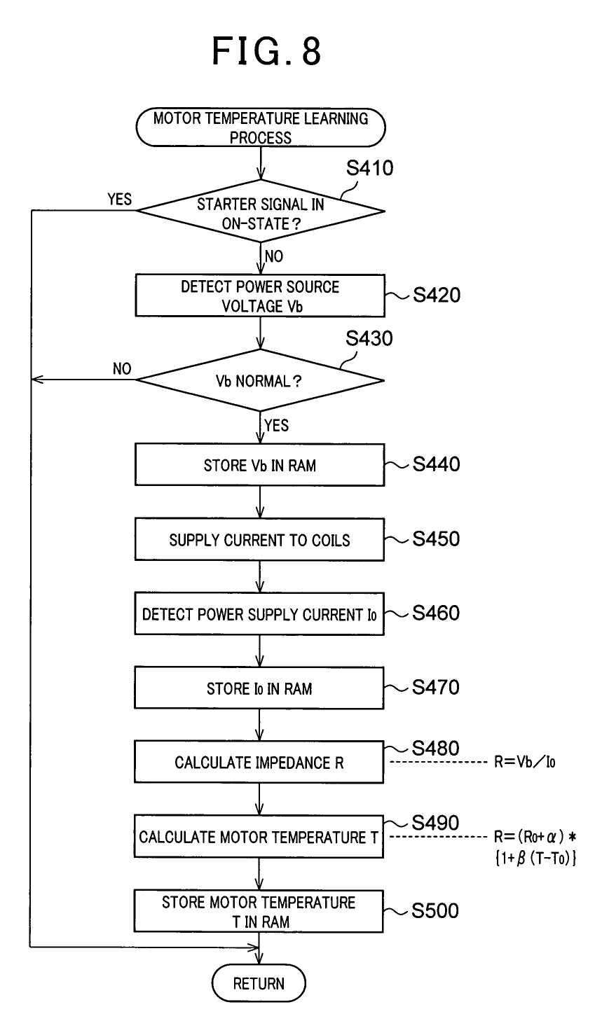

The current detection resistor 59 is provided for detecting power supply current when current is supplied to the coils in any of the phases of the SR motor 33, in an initial assemblage error learning process (see FIG. 6) or a motor temperature learning process (see FIG. 8), which will be described later. Voltage (corresponding to power supply current) at one end (opposite to the grounding side) of the current detection resistor 59 is inputted to the current detection circuit 60. The inputted voltage is adequately amplified in the current detection circuit 60 and inputted to an A/D converter 61.

The purpose of detecting the power supply current conducted by the current detection resistor 59 in the present embodiment is different from that of the conventional power supply current detection that has been described referring to FIG. 16. That is, the conventional power supply current detection has been purposed to perform the current F/B control for the SR motor, whereas the power supply current detection in the present embodiment is not purposed to perform the current F/B control. As will be described in detail later, the power supply current detection of the present embodiment is conducted for the purpose of calculating an impedance compensation amount α or a torque compensation coefficient A, or for the purpose of learning the motor temperature (of calculating temperature the SR motor 33) in the actual usage being loaded on a vehicle.

The motor control ECU 35 includes: the CPU 51 for performing overall control of the SR motor 33; an ROM 52 in which various control programs and various maps are stored for use when deriving current supply patterns for the phase coils 5, 6 and 7; an RAM 53 for use when the CPU 51 executes various calculations; an EEPROM 54 serving as a nonvolatile memory, which is electrically rewritable and stores various types of data, such as the various programs, as well as the impedance compensation amount α and the torque compensation coefficient A mentioned above; the motor drive circuit 55 for driving the SR motor 33 by driving the FETs 56, 57 and 58 (by turning on/off the FETs) based on commands from the CPU 51; a power source voltage detection circuit 62 for detecting the power source voltage Vb (battery voltage); and the A/D converter 61 for A/D converting data (voltage corresponding to the power source voltage Vb) detected by the power source voltage detection circuit 62 or the output voltage of the current detection circuit 60. All of these elements are interconnected through a data bus 63. An external interface (i.e. external-connection connector) 64 is connected to the data bus 63, so that the external inspection apparatus 66 and the motor control ECU 35 can be connected through the external interface 64. In such a configuration, the motor control ECU 35 controls current supply to the phase coils 5, 6 and 7 and controls the driving of the SR motor 33 based on commands from a shift-change control unit (not shown) and information from a sensor (not shown), such as an encoder, which detects information on the operation of a motor. It should be appreciated that in the present embodiment, description is focused on the torque control and description on other controls are omitted.

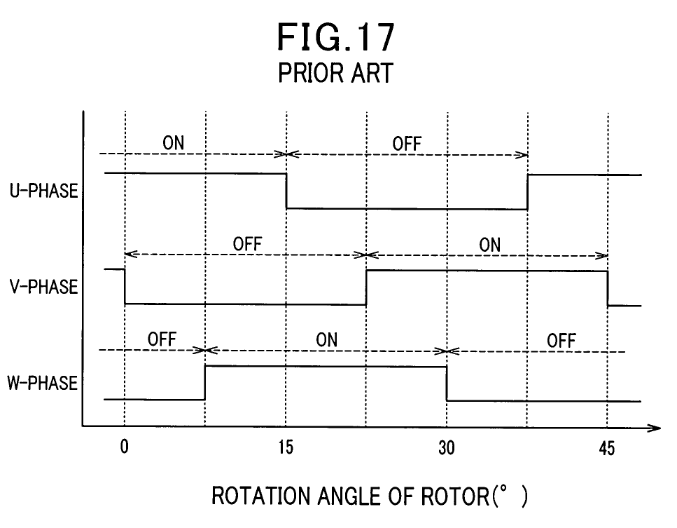

As will be described later, the external inspection apparatus 66 is used in calculating the impedance compensation amount α and the torque compensation coefficient A when the switching/driving apparatus 3 is manufactured and shipped from the factory (at the time of factory shipment). The impedance compensation amount α is associated with the impedance of the coils of the SR motor 33 (the impedance of the U-phase coils 5 in the present embodiment), and indicates a difference between an actual value and a design center value R₀ under the same temperature conditions. In other words, the impedance compensation amount α is provided for compensating (correcting) the variation between a design center value and an actual value concerning the number of turns in a winding of a coil or a diameter of a coil. The torque compensation coefficient A indicates a ratio of an actually generated torque when current is actually supplied to the SR motor 33 with a predetermined pattern (the conventional current supply pattern shown in FIG. 17, in the present embodiment) under the same temperature conditions, to a design center torque value. In other words, the torque compensation coefficient A is provided for compensating (correcting) the dimensional variation of parts (e.g., stators 36 or rotors 38) structuring the SR motor 33, or the dimensional variation between the parts in the state of being assembled.

As described above, the impedance of the phase coils 5, 6 and 7 changes in response to the ambient temperature of the SR motor 33. Constant impedance can naturally involve change in the current with the change in the power source voltage Vb. Therefore, setting a target torque in a single uniform way irrespective of the temperature and the power source voltage and performing current supply using a current supply pattern for achieving thus set target torque, can result in an actual torque which is different from the target torque, depending on the temperature and the power source voltage. Thus, a desired torque may not be obtained or a large torque of more than necessary may be generated.

To cope with this, the present embodiment is configured to actually detect a temperature T of the SR motor 33 and derives a suitable target torque corresponding to the detected actual temperature T, so that current can be supplied to the SR motor 33 with a current supply pattern suitable for the target torque. In detecting the temperature, no detection element, such as a temperature sensor, is separately provided, but current is actually supplied to the SR motor 33 (test current supply) to calculate an actual impedance R of the moment, whereby the temperature T is calculated using the calculated impedance R. The impedance compensation amount α is used in the calculation of the temperature T.

Even under the same conditions, the generated torque may naturally be varied for every motor, depending on the individual differences of motors (e.g., dimensional variation between parts, such as a rotor and a stator, or dimensional variation between parts when assembled). Therefore, setting the same target torque may result in an actual torque which is different between motors.

To cope with this, in deriving a target torque corresponding to the temperature T and the power source voltage Vb, the present embodiment first calculates a virtual target torque TR₀, assuming that the parts constituting the SR motor 33 are each in an ideal state of satisfying the design center value from the aspects of the dimension of the parts and the dimension at the time of assemblage (hereinafter referred to as “assemblage dimension”). Subsequently, the virtual target torque TR₀ is compensated (or corrected) by the torque compensation coefficient A to derive a real target torque TR.

Although not shown, the SR motor 33 is provided with an encoder for detecting a rotational position of the rotor 38. The CPU 51 is adapted to sequentially switch the phases to be supplied current of the SR motor 33 in response to detection signals from the encoder to rotate and drive the rotor 38.

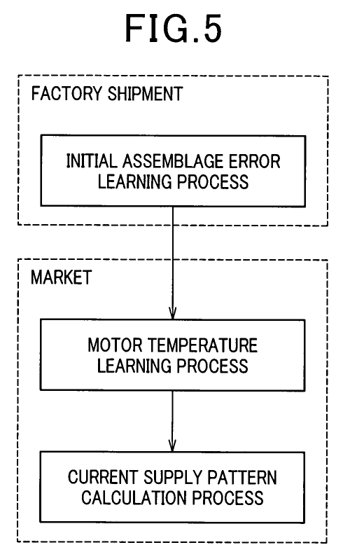

With reference to FIG. 5, hereinafter are described some processes performed for the switching/driving apparatus 3 from the point it is shipped from a factory to the point it is loaded on a vehicle. As shown in FIG. 5, an initial assemblage error learning process is executed for the manufactured switching/driving apparatus 3 when it is shipped from the factory. The initial assemblage error learning process is executed by connecting the external inspection apparatus 66 to the motor control ECU 35, i.e. in cooperation with the motor control ECU 35 and the external inspection apparatus 66. Also, the initial assemblage error learning process is executed under the conditions of the design reference temperature T₀ preset for the motor control ECU 35. The details of the process are shown in FIG. 6.

FIG. 6 is a flow diagram illustrating the initial assemblage error learning process. The initial assemblage error learning process is started and executed in both of the motor control ECU 35 and the external inspection apparatus 66 upon interconnection therebetween. The initial assemblage error learning process on the side of the motor control ECU 35 is periodically executed.

With the start of the initial assemblage error learning process, the external inspection apparatus 66 outputs first a command “mode=1” as an inspection mode to the motor control ECU 35 (step S310), and stands ready to an input of a notification of the impedance compensation amount α as having been calculated from the motor control ECU 35 (step S320).

On the other hand, with the start of the initial assemblage error learning process, the motor control ECU 35 determines first whether or not its inspection mode has been set in the “mode=1” (step S110). Specifically, when the command for setting the inspection mode is inputted from the external inspection apparatus 66, the motor control ECU 35 is adapted to set its inspection mode according to the command. Thus, the motor control ECU 35, if its mode is set in the “mode=1” according to the setting command “mode=1” from the external inspection apparatus 66 (YES at step SI 10), supplies current to the coils in the SR motor 33 (step S120).

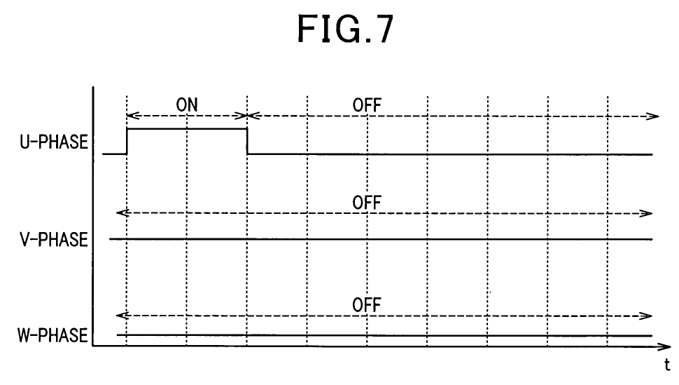

The current supply at this step is performed based on a reference current supply pattern shown in FIG. 7. To put it another way, the current supply is performed only for a certain period of time for the U-phase coils 5 just as a learning process prior to the shipment. In particular, the CPU 51 outputs a command to the motor drive circuit 55 according to the reference current supply pattern, so that the motor drive circuit 55 can turn on the FET 56. It should be appreciated that the objects to be supplied current are not necessarily the U-phase coils 5, but may be the V-phase coils 6 or the W-phase coils 7.

During the current supply according to the reference current supply pattern, the motor control ECU 35 detects a power supply current I₀ (step S130) and the power source voltage Vb (step S140). In other words, the motor control ECU 35 retrieves the power supply current I₀ and the power source voltage Vb that have been detected by the current detection circuit 60 and the power source voltage detection circuit 62 and A/D converted by the A/D converter 61, and temporarily stores the retrieved data in the RAM 53. Then, the motor control ECU 35 calculates initial impedance (step S150) of the coils (the U-phase coils 5 in the present embodiment) based on the retrieved power supply current I₀ and the power source voltage Vb. This calculation can be readily performed by a division Vb/I₀, utilizing the well known Ohm's law.

A difference between the calculated initial impedance and the reference impedance R₀ is calculated as the impedance compensation amount α (step S160). The reference impedance R₀ represents a design impedance, or a design center value, of the U-phase coils 5 under the conditions of the reference temperature To.

The impedance compensation amount α calculated in this way is stored in the EEPROM 54 (step S170). The motor control ECU 35 then outputs a notification to the external inspection apparatus 66 that the impedance compensation amount α has been calculated (step S180), and resets the inspection mode (step S190).

Meanwhile, the external inspection apparatus 66, upon reception of the notification inputted from the motor control ECU 35 at step S180 (YES at step S320), outputs a command “mode=2” as another inspection mode to the motor control ECU 35 (step S330) and stands ready to an input of initial torque from the motor control ECU 35 (step S340).

In the motor control ECU 35, after calculating the impedance compensation amount α, upon input of the setting command “mode=2” from the external inspection apparatus 66, the inspection mode of the motor control ECU 35 is set in the “mode=2” (YES at step S200). Then, the motor control ECU 35 supplies current to the phase coils 5, 6 and 7 in the SR motor 33 to actually drive the SR motor 33 (step S210). Unlike the current supply at step S120 mentioned above, the current supply at this step is the one based on the conventional current supply pattern shown in FIG. 17. In other words, current is supplied to the SR motor 33 in the same manner as in the conventional apparatus.

Subsequently, during this current supply, the motor control ECU 35 measures an initial torque of the SR motor 33 using an external torque measuring apparatus (not shown) (step S220). Specifically, the motor control ECU 35 actually measures the torque that would be generated through the conventional current supply under the conditions of the design reference temperature T₀. After the measurement of the initial torque by the torque measuring apparatus, the measured initial torque data is inputted to the external inspection apparatus 66.

When the initial torque is inputted (YES at step S340), the external inspection apparatus 66 calculates a ratio between a preset reference torque and the inputted initial torque as the torque compensation coefficient A (step S350). The reference torque is a design torque, or a design center value, generated during the current supply according to the current supply pattern shown in FIG. 17 under the conditions of the design reference temperature T₀. The external inspection apparatus 66 outputs the calculated torque compensation coefficient A to the motor control ECU 35 (step S360) and stands ready to an input of a notification from the motor control ECU 35 indicating the completion of the initial assemblage error learning process (step S370).

The motor control ECU 35, upon input of the torque compensation coefficient A from the external inspection apparatus 66 (YES at step S230), stores the inputted torque compensation coefficient A in the EEPROM 54 (step S240). The motor control ECU 35 then outputs the completion notification to the external inspection apparatus 66 (step S250), resets the inspection mode (step S190) and terminates the initial assemblage error learning process. When the completion notification is inputted from the motor control ECU 35 (step S370), the external inspection apparatus 66 also terminates the initial assemblage error learning process. After terminating the process, the external inspection apparatus 66 is disconnected from the motor control ECU 35.

As a result, the EEPROM 54 of the motor control ECU 35 is stored with the impedance compensation amount α and the torque compensation coefficient A, which are suitable for the SR motor 33 integrated into the motor control ECU 35. In this way, the switching/driving apparatus 3 is shipped from the factory with the values of α and A being stored.

The switching/driving apparatus 3 that has been subjected to the initial assemblage error learning process at the time of the factory shipment will then be marketed, actually loaded on a vehicle and used. Referring to FIG. 5 again, in the actual usage, a motor temperature learning process and a current supply pattern calculation process are carried out.

With reference to FIG. 8, the motor temperature learning process will be described. FIG. 8 is a flow diagram illustrating the motor temperature learning process, which is performed by the CPU 51 of the motor control ECU 35. The CPU 51 performs this process according to a motor temperature learning program which is read out of the ROM 52. The motor temperature learning process is consecutively performed at a predetermined interval after an ignition switch of the vehicle is turned on.

When this process is started, it is determined first whether or not a starter signal is in an on-state, that is, whether or not a starter (start up motor) (not shown) for starting the engine of the vehicle is in operation (step S410). The motor control ECU 35, although not shown in FIG. 4, is configured in such a way that the starter signal can be inputted.

If the starter signal is in an on-state (YES at step S410), since this means that the starter is in operation and the power source voltage Vb is being reduced (unstable), the motor temperature learning process is ended. On the other hand, if the starter is not in operation and the starter signal is in an off-state (NO at step S410), the power source voltage Vb is detected (step S420). The detected power source voltage Vb is then determined as to its normality (step S430).

It should be appreciated that the power source voltage Vb is normally 12V in the present embodiment. Accordingly, the determination as to the normality of the detected power source voltage Vb is made by determining whether or not the detected voltage falls within a range, for example, of 6 to 16V. The power source voltage Vb may be detected only once to make a determination on the single detected data as to its normality, or may be detected a plurality of times at a certain interval to make a determination on the detected data as to whether or not all of the data fall within the above range or as to whether or not an average of the data falls within the above range.

If the detected power source voltage Vb is not normal (NO at step S430), the motor temperature learning process is ended. If the detected power source voltage Vb is normal (YES at step S430), the power source voltage Vb is temporarily stored in the RAM 53 (step S440). Then, current is supplied to the U-phase coils 5 according to the reference current supply pattern shown in FIG. 7 (step S450), and the power supply current I₀ of the moment is detected (step S460). The detected power supply current I₀ is then temporarily stored in the RAM 53 (step S470).

When the power supply current I₀ and the power source voltage Vb have been obtained in this way, the impedance R of the U-phase coils 5 is calculated based on the obtained values (step S480). This calculation can also be readily performed by a division Vb/I₀ utilizing the well known Ohm's law. The resultant impedance R is the actual impedance (in particular, the actual impedance of the U-phase coils 5) of the SR motor 33 under the temperature conditions where the SR motor 33 is actually put.

The temperature T of the SR motor 33 is then calculated using this impedance R (step S490). In particular, the impedance R can be expressed by the following Formula (3):

R=(R₀+α)*{1+β(T−T₀)} (3)

where R₀ is a reference impedance of the U-phase coils 5 at the design reference temperature T₀, β is a temperature coefficient and T is a temperature to be calculated. Formula (3) is a known formula expressing a relation between impedance and temperature. Using this Formula (3), the actual temperature T of the coils can be obtained through an operation. For example, by transforming the formula so that its left-hand side is made up of only T, the temperature T may be readily calculated.

In case the reference impedance of the U-phase coils 5 coincides with the design center value R₀, the value a in the right-hand side of Formula (3) is not necessary. As a matter of fact, however, the actual reference impedance does not coincide with the design center value R₀, as described above, due to the variations, such as in the number of turns in a winding of a coil or the diameter of a coil. For this reason, the reference impedance is compensated (corrected) using the impedance compensation amount α that has been calculated in the initial assemblage error learning process (see FIG. 6) at the time of factory shipment.

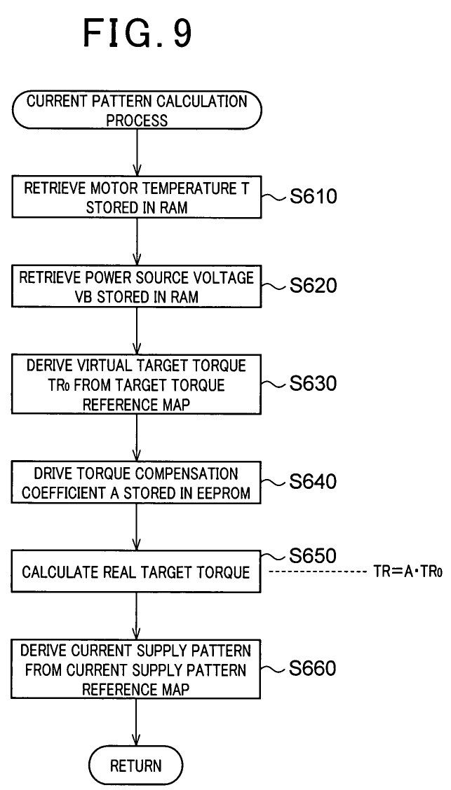

The temperature T (i.e., the actual temperature at the time of calculation) of the U-phase coils 5 obtained in this way is stored in the RAM 53 as the temperature T of the SR motor 33 (step S500) to end the motor temperature learning process. Subsequent to the end of the motor temperature learning process, control proceeds to a current supply pattern calculation process shown in FIG. 9.

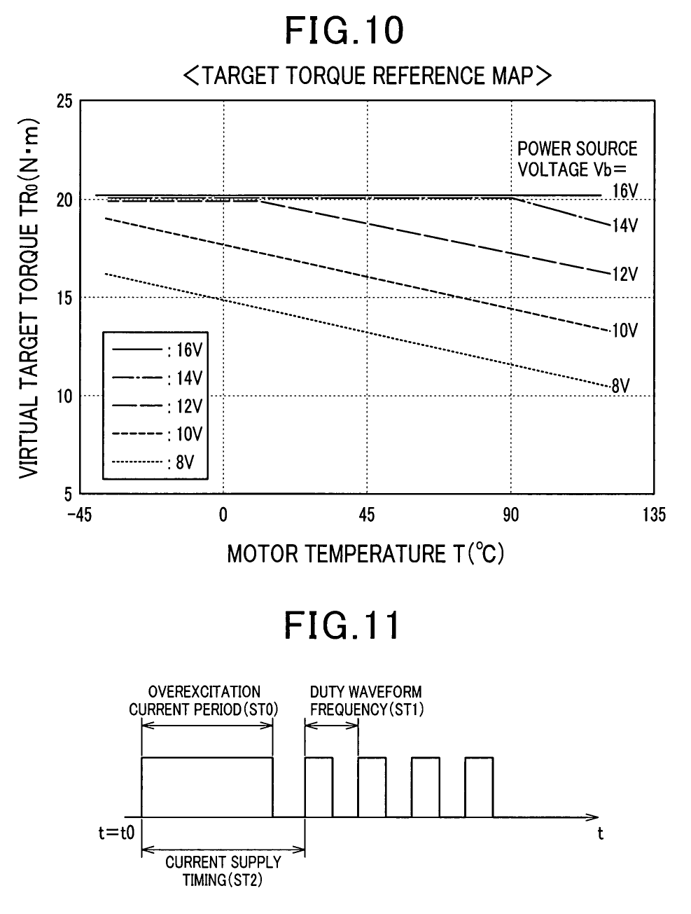

Referring now to FIG. 9, the current supply pattern calculation process will be described. Upon start of the current supply pattern calculation process, the motor temperature T and the power source voltage Vb stored in the RAM 53 are retrieved first (steps S610 and S620). A tentative target torque, or the virtual target torque TR₀, is derived based on the motor temperature T and the power source voltage Vb, while referring to a target torque reference map shown in FIG. 10 (step S630).

As shown in FIG. 10, the target torque reference map indicates the temperature T relative to the virtual target torque TR₀ for every power source voltage Vb. The target torque reference map is obtained by measuring the torque of the SR motor 33 by supplying current thereto according to the conventional current supply pattern shown in FIG. 17 while varying the conditions of the temperature T and the power source voltage Vb of the SR motor 33, and by plotting the results of the measurement as the virtual target torque TR₀. Specifically, for example, when current was actually supplied at a temperature of 90° C. with the power source voltage Vb being 12V, the actually measured torque was 16.9 N·m, and this actually measured torque was plotted, as it was, as the virtual target torque TR₀ at the above temperature and voltage. In short, the map contains the torque obtained by using the conventional current supply pattern, as a tentatively used target torque.

However, in order that the shift range switching mechanism 1 is not affected by a failure, for example, due to excessive torque, an upper limit (20 N·m in the present embodiment) is provided for the virtual target torque TR₀, so that the virtual target torque TR₀ can be determined within the range whose maximum value is equal to or less than the upper limit. For example, where the power source voltage Vb is 14V, and the temperature T becomes lower than 90° C., the actually measured torque rapidly increases exceeding 20 N·m. However, the torque exceeding 20 N·m is all plotted as the upper limit 20 N·m. Use of the target torque reference map obtained in this way may lead to the derivation of the virtual target torque TR₀ suitable for the power source voltage Vb and the motor temperature T. Although FIG. 10 shows only five power source voltages Vb, i.e. 8V, 10V, 12V, 14V and 16V, as to the power source voltages Vb other than these values, the virtual target torque TR₀ may be derived by a linear complement, for example, using the characteristics of two or more of the five voltages.

After deriving the virtual target torque TR₀ using the target torque reference map of FIG. 10, the torque compensation coefficient A stored in the EEPROM 54 is retrieved (step S640). The real target torque TR is then calculated by compensating the virtual target torque TR₀ with the torque compensation coefficient A (step S650). The real target torque TR can be readily calculated using the following Formula (4):

TR=A*TR₀ (4)

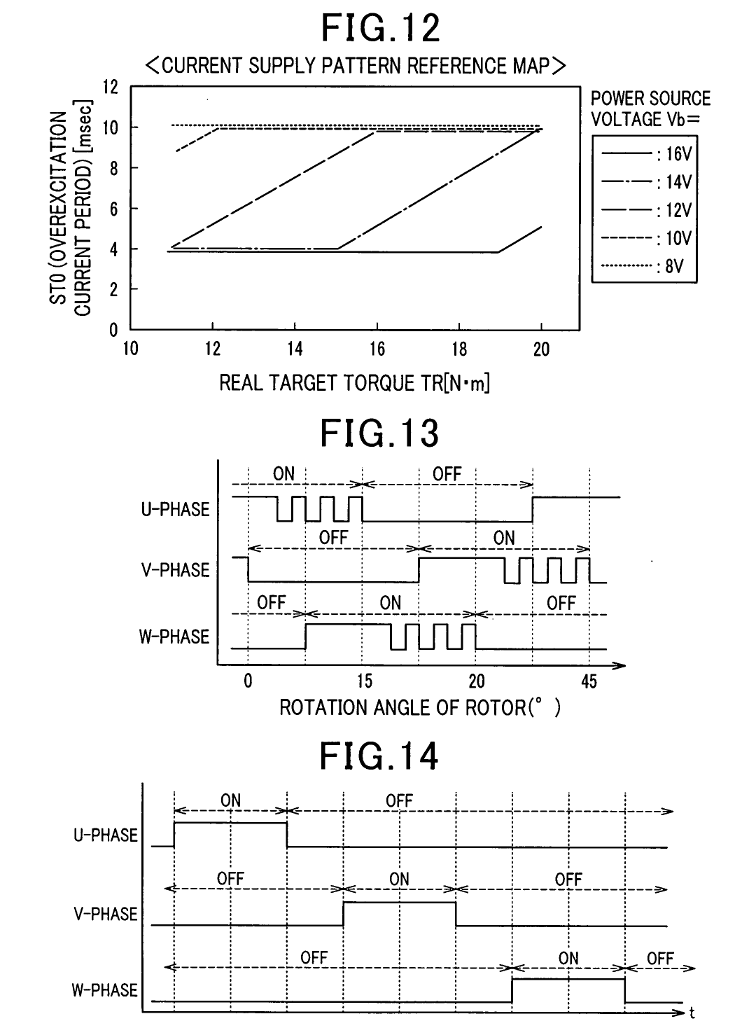

Following the calculation of the real target torque TR, actual current supply patterns for the phase coils 5, 6 and 7 in the SR motor 33 are derived from a current supply pattern reference map shown in FIG. 12 (step S660).

With reference to FIG. 11, a current supply pattern for the SR motor 33 of the present embodiment will now be described in detail. FIG. 11 illustrates a real current pattern of the present invention during one current supply period (corresponding to the current supply period in FIG. 17 for bringing each phase into an on-state). This current supply pattern is common to the phase coils 5, 6 and 7.

Conventionally, current has been supplied continuously during one current supply period to bring the coils into an on-state. However, as shown in FIG. 11, the current supply pattern of the present embodiment permits continuous current supply (on-state) during a predetermined overexcitation current period ST0 which starts with the commencement of the current supply, among the entire current supply period. Then, from the point of current supply timing ST2 that has been reached after the overexcitation current period ST0, current is supplied at a predetermined duty ratio with a waveform frequency ST1 (hereinafter referred to as “duty current supply”).

In the present embodiment, the duty ratio and the waveform frequency ST1 at the duty ratio (hereinafter referred to as “duty waveform frequency ST1”) during the duty current supply are rendered to be constant irrespective of the power source voltage Vb and the motor temperature T, and the overexcitation current time ST0 is ensured to vary according the power source voltage Vb and the motor temperature T. The period from the end of the overexcitation current time ST0 to the commencement of the duty current supply in the present embodiment is constantly 10 msec. In other words, the time point that has been reached 10 msec after the end of the overexcitation current period ST0 is the start timing (i.e. the current supply timing ST2) of the duty current supply. Thus, the derivation process for the current supply pattern at step S660 is substantially a process of deriving the overexcitation current period ST0 suitable for the power source voltage Vb and the motor temperature T of the moment, from the current supply pattern reference map of FIG. 12.

The current supply pattern reference map of FIG. 12 shows the overexcitation current period ST0 relative to the real target torque TR for every power source voltage Vb. This current supply pattern reference map is obtained by measuring the time required for reaching the real target torque TR from the commencement of the current supply while actually supplying current to the SR motor 33 and measuring the torque of the moment, and by plotting the results of the measurement. The map sets an upper limit (10 msec) and a lower limit (4 msec), so that all the values are rendered to fall within the range. In this way, neither too much nor too little overexcitation current period ST0 can be set under any condition, to generate sufficient torque as required.

Current is then actually supplied to the phase coils 5, 6 and 7 according to the current supply pattern obtained in this way. The current supply is performed, in particular, according to the current supply pattern shown in FIG. 13. The shift range switching mechanism 1 is suitably driven by this current supply.

The shift range switching mechanism 1 according to the present embodiment described above can set a target torque suitable for the temperature T and the power source voltage Vb of the SR motor 33 to provide a current control suitable for the temperature T and the power source voltage Vb. Thus, irrespective of the level of the operating temperature and the power source voltage Vb, suitable torque can be generated in the SR motor 33. In this way, the parts structuring the shift range switching mechanism 1 can be prevented from being imposed with an overload, whereby the quality and the reliability of the products can be enhanced.

Moreover, the temperature T is calculated by calculating the impedance R of the coils and by performing a numerical operation based on the calculated impedance R, without providing a detector, such as a semiconductor temperature sensor. Thus, the temperature T can be detected with accuracy without physically increasing components.

As described above, the reference impedance R₀ (design center value) at the reference temperature T₀ of the subject coils is compensated with the impedance compensation amount α, and based on the compensated reference impedance (R₀+α), the temperature T is calculated. Thus, this compensation can absorb the individual difference (in the number of turns in a winding of a coil or the diameter of a coil, for example) of the SR motor to enable more accurate calculation of the temperature T. Accordingly, setting a target torque using the accurately calculated temperature T enables high-accuracy control of the SR motor 33.

In setting the target torque (virtual target torque TR₀), the target torque reference map of FIG. 11 is used, whereby a suitable target torque can be readily determined.

The present embodiment derives a target torque suitable for the temperature T and the power source voltage Vb from the target torque reference map. The target torque derived from the target torque reference map is regarded just as a tentative value (virtual target torque TR₀), and this virtual target torque TR₀ is then compensated with the torque compensation coefficient A to obtain the real target torque TR.

In other words, the individual difference (e.g., variation in dimension) of the SR motor 33 is absorbed by the torque compensation coefficient A, so that a more suitable target torque can be determined for the particular SR motors 33.

In actually supplying current (in driving the SR motor 33) for switching the shift range, the current supply periods to the phase coils 5, 6 and 7 are permitted to overlap with each other (see FIG. 13). However, since the current supply in calculating the impedance compensation amount α (step S130 of FIG. 6) or the temperature T (step S460 of FIG. 8) is independently conducted for any one of the phases (the U-phase coils 5, in the present embodiment), only the single common current detection resistor 59 and the single common current detection circuit 60 may suffice. Thus, the size of the motor control ECU 35 can be significantly reduced, leading to the reduction in the size of the entire switching/driving apparatus 3.

In the present embodiment, the current supply pattern in a current supply period of each phase involves a continuous current supply from the start of the current supply until the expiration of the overexcitation current period ST0, and involves a duty current supply at a predetermined duty ratio after expiration of a certain period that follows the overexcitation current period ST0 (i.e. after the current supply timing ST2 has been reached since the start of the current supply period). Further, the overexcitation current period ST0 is derived from the current pattern reference map based on the real target torque TR and the power source voltage Vb. Thus, a current supply pattern suitable for the temperature T and the individual difference of the SR motor 33 can be readily derived. In addition, a desired torque can be more promptly obtained (owing to the overexcitation current period ST0), while a torque of more than necessary can be suppressed from being generated (owing to the duty current supply), whereby more appropriate torque control can be realized with less torque variation.

As a matter of fact, thermal stress caused by long-term use of a vehicle may vary the electrical characteristics of the coils per se as well as the external parts, such as a harness or a connector for connecting between the SR motor 33 and a power source. The present embodiment, however, can perform appropriate current supply, taking into account of such external factors. Thus, torque can be controlled considering the aged deterioration of the vehicle parts.

It should be appreciated that: the EEPROM 54 corresponds to the first storing means and the second storing means of the present invention; the target torque reference map of FIG. 10 corresponds to the target torque map of the present invention; the current supply pattern reference map of FIG. 12 corresponds to the actual current supply pattern map of the present invention; the impedance compensation amount α corresponds to the reference impedance compensation amount of the present invention; and the torque compensation coefficient A corresponds to the torque compensation amount of the present invention.

It should also be appreciated that: the motor temperature learning process of FIG. 8 corresponds to the process executed by the temperature detecting means of the present invention; both of step S120 of FIG. 6 and step S450 of FIG. 8 correspond to the process executed by the reference current supplying means of the present invention; both of step S150 of FIG. 6 and step S480 of FIG. 8 correspond to the process executed by the impedance calculating means of the present invention; step S160 of FIG. 6 corresponds to the process executed by the reference impedance compensation amount calculating means of the present invention; step S350 of FIG. 6 corresponds to the process executed by the torque compensation amount calculating means of the present invention; step S630 of FIG. 9 corresponds to the process executed by the target torque setting means of the present invention; steps S640 and S650 of FIG. 9 correspond to the process executed by the target torque compensation means of the present invention; and step S660 of FIG. 9 corresponds to the process executed by the actual current supplying means of the present invention.

As a matter of course, the present invention should not be limited to the embodiment that has been described above, but can be implemented in various ways without departing from the spirit of the present invention.

In the embodiment described above, the current supply at step S120 of FIG. 6 (current supply in calculating the impedance compensation amount α) and the current supply at step S450 of FIG. 8 (current supply in calculating the motor temperature T) have been performed for the coils of only any one of the phases (the U-phase, in the above embodiment) using the reference current supply pattern of FIG. 7. Alternatively, current may be supplied to the individual phase coils 5, 6 and 7 as shown in FIG. 14. In other words, the impedance compensation amount α may be calculated for each of the phases to separately calculate the temperature T for each of the phases based on the calculated impedance compensation amount α.

In case the temperature T is calculated for each of the phases, a suitable virtual target torque TR₀ may be derived from the target torque reference map by, for example, obtaining an average value or an intermediate value of the calculated temperatures T. In this way, accuracy can be enhanced in the temperature learning process or in the calculation of the virtual target torque TR₀, whereby the quality and the reliability of the products can be enhanced.

In the embodiment described above, the actual current supply pattern of the SR motor 33 has involved variation of only the overexcitation current period ST0, while fixing other values of the duty waveform frequency ST1 and the current supply timing ST2 as described referring to FIG. 11. Alternative to this, both of the overexcitation current period ST0 and the duty waveform frequency ST1 may be varied.

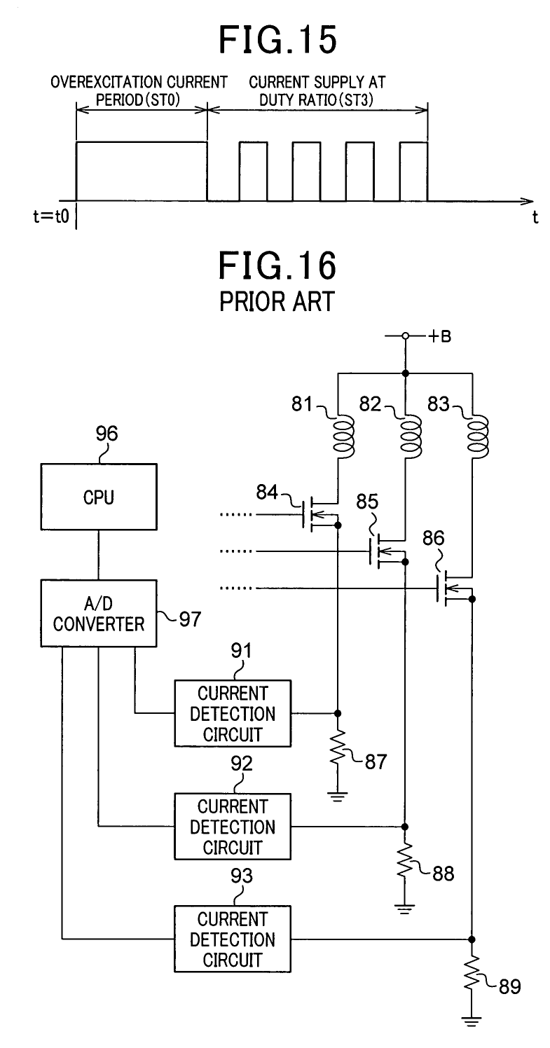

Alternatively, as shown in FIG. 15, the overexcitation current period ST0 may be fixed, and a duty ratio ST3 in the subsequent duty current supply period may be varied. In this case, a variation tendency can be the same as that of the overexcitation current period ST0 shown in FIG. 12. Alternatively, both of the overexcitation current period ST0 and the duty ratio ST3 may be varied.

In the above embodiment, the target torque reference map of FIG. 10 has had a tendency that the temperature and the virtual target torque TR₀ are in inverse proportion. Alternative to this, various maps may be employed as far as a torque, which is lower than the upper limit (20 N·m) and actually available, can be set as the virtual target torque TR₀.

In the above embodiment, the impedance compensation amount α has been a “difference” and the torque compensation amount A has been a “ratio”. However, each of the values α and A may be either the “difference” or the “ratio”.

In the above embodiment, the temperature of the phase coils 5, 6 and 7 in the SR motor 33 has not been directly detected, but has been indirectly detected utilizing parameters concerning temperature.

Alternatively, the temperature of the SR motor 33 or of the phase coils 5, 6 and 7 may be directly detected by providing a temperature sensor in the vicinity of the SR motor 33 or the phase coils 5, 6 and 7, or by providing a temperature sensor inside the motor control ECU 35 or in the vicinity thereof, or by directly detecting a temperature, which is alternative to the temperature of the SR motor 33 or the phase coils 5, 6 and 7. Such a direct detection may eliminate or simplify the inspection process at the time of the factory shipment shown in FIG. 6, for example, or the control flow of temperature calculation shown in FIG. 8, for example. Also, other advantages can be expected, such as the enhancement of workability, reduction in the operation load of the CPU 51 and saving room for memory capacity.

The present invention may be embodied in several other forms without departing from the spirit thereof. The embodiments and modifications described so far are therefore intended to be only illustrative and not restrictive, since the scope of the invention is defined by the appended claims rather than by the description preceding them. All changes that fall within the metes and bounds of the claims, or equivalents of such metes and bounds, are therefore intended to be embraced by the claims.

What is claimed is:

1. An apparatus for controlling drive of a motor mounted on a vehicle and formed to have a rotor and a stator equipped with a plurality of phases of coils to be supplied by current in turn, phase by phase, to rotate the rotor, the apparatus comprising:
a voltage detector that detects a voltage of power to be applied to the motor;
a temperature detector that detects a temperature of the motor;
a setting block that uses the detected temperature and the detected voltage of the power to set a target torque at which the motor should generate a torque; and
a current-supply block that supplies current to the motor so that the motor generates the torque on the target torque set by the setting block.

2. The apparatus of claim 1, wherein
the temperature detector comprises
a current supplier that supplies current to, of the plurality of phases of the coils, one or more coils of corresponding one or more phases on a given current-supply pattern;
a current detector, which are used in common among the plurality of phases of coils, that detects a current flowing when the current supplier supplies the current on the given current-supply pattern;
a first calculator that calculates an impedance of the one or more coils supplied with the current by the current supplier, on the basis of the detected voltage of the power and the current detected by the current detector; and
a second calculator that calculates, as an alternative amount to the temperature of the motor, a temperature of the coil on the basis of the impedance calculated by the first calculator and a reference impedance previously set for the one or more coils at a given reference temperature.

3. The apparatus of claim 2, wherein the reference impedance is a central value of impedances designed for the one or more coils.

4. The apparatus of claim 2, comprising
an actual impedance detector that detects an actual impedance of the one or more coils at the reference temperature;
an impedance compensating-amount calculator that calculates a compensating amount for the reference impedance on the basis of the actual impedance of the one or more coils and the reference impedance; and
a first storage storing therein the compensating amount for the reference impedance;
wherein the second calculator is configured to correct the reference impedance on the compensating amount stored in the first storage and to calculate the temperature of the coil using the compensated reference impedance.

5. The apparatus of claim 4, wherein the impedance compensating-amount calculator is configured to calculate, as the compensating amount for the reference impedance, either a ratio or a difference between the actual impedance and the reference impedance.

6. The apparatus of claim 4, wherein
the actual impedance detector comprises
current supply means that supplies, at the reference temperature, current to, of the plurality of phases of the coils, one or more coils of corresponding one or more phases on a given current-supply pattern;
current detecting means, which are used in common among the plurality of phases of coils, that detects, at the reference temperature, a current flowing when the current supply means supplies the current on the given current-supply pattern; and
impedance calculating means that calculates an impedance of the one or more coils supplied with the current by the current supply means, on the basis of the detected voltage of the power and the current detected by the current detecting means.

7. The apparatus of claim 1, wherein
the target torque is a torque less than a predetermined maximum torque and obtained by the motor operating on the detected voltage of the power at the detected temperature.

8. The apparatus of claim 6, comprising
a map in which the target torque is written depending on each of temperatures of the motor and each of voltages of the power,
the setting block is configured to set the target torque by making the detected temperature and the detected voltage of the power refer to the map.

9. The apparatus of claim 1, comprising
a reference torque detector that detects a reference torque that is a central torque value of designed torques generated by the motor on a given current-supply pattern at the reference temperature;
an actual torque detector that detects an actual torque generated by the motor and measured on the given current-supply pattern at the reference temperature;
a torque compensating-amount calculator that calculates a compensating amount for a toque generated by the motor, on the basis of the reference torque and the actually measured torque; and
a second storage that stores therein the compensating-amount for the torque,
wherein the setting block includes means for using the compensating-amount for the torque stored in the second storage to correct the target torque on the compensating amount, the compensated toque being given by the current-supply block.

10. The apparatus of claim 1, comprising
a further map in which actual current-supply patterns are written depending on each of voltages of the power and each of target torques, the actual current-supply patterns being used by the current-supply block when the current-supply block supplies the current to the coils of the respective phases in turn,
wherein the current-supply block is configured to supply the current to the motor by making reference to the further map to decide a desired current-supply pattern from the actual current-supply patterns on the basis of the voltage of the power and the target toque.

11. The apparatus of claim 10, wherein
each of the actual current-supply patterns includes a first period of time starting at a beginning timing of each actual current-supply pattern and continuously lasting for supplying the current and a second period of time following the first period of time and lasting on on/off duty control of the current, and
the further map includes at least one of information indicative of the first period of time or information indicative of the second period of time depending on each of the voltages of the power and each of the target torques.

12. The apparatus of claim 1, comprising
a determining block that determines whether or not a starter for an internal combustion engine mounted in the vehicle is in operation,
wherein the voltage detector includes means for suspending the detection of the voltage of the power during a period of time during which the determining block determines that the starter is in operation.

13. The apparatus of claim 1, comprising
a further determining block that determines whether or not the voltage of the power detected by the voltage detector is in a range of normal voltages; and
an invalidating block that invalidates the voltage of the power when the further determining block determines that the voltage of the power detected by the voltage detector is not in the range of the normal voltages.

14. The apparatus of claim 1, wherein the motor is a switched reluctance motor.

15. The apparatus of claim 1, wherein the motor is mounted in a shift range switching mechanism for an automatic transmission mounted on the vehicle, the torque generated by the motor being given to the shift range switching mechanism for switching shift ranges thereof.

16. The apparatus of claim 1, composed as an integrated apparatus with the motor.

17. The apparatus of claim 2, wherein
the target torque is a torque less than a predetermined maximum torque and obtained by the motor operating on the detected voltage of the power at the detected temperature.

18. The apparatus of claim 3, wherein
the target torque is a torque less than a predetermined maximum torque and obtained by the motor operating on the detected voltage of the power at the detected temperature.

19. The apparatus of claim 4, wherein
the target torque is a torque less than a predetermined maximum torque and obtained by the motor operating on the detected voltage of the power at the detected temperature.

20. A method of controlling drive of a motor mounted on a vehicle and formed to have a rotor and a stator equipped with a plurality of phases of coils to be supplied by current in turn, phase by phase, to rotate the rotor, the method comprising steps of:
first detecting a voltage of power to be applied to the motor;
second detecting a temperature of the motor based on the detected voltage of the power;
using the detected temperature and the detected voltage of the power to set a target torque at which the motor should generate a torque; and
supplying current to the motor so that the motor generates the torque on the target torque set by the setting step.
